(19) United States
(12) Patent Application Publication
(10) Pub. No.: US 2016/0142398 A1
(43) Pub. Date: May 19, 2016

(54) Method of network identity authentication by using an identification code of a communication device and a network operating password

(71) Applicant: CHUNG-YU LIN, Kaohsiung City (TW)

(72) Inventor: CHUNG-YU LIN, Kaohsiung City (TW)

(21) Appl. No.: 14/324,590

(22) Filed: Jul. 7, 2014

Related U.S. Application Data
(60) Provisional application No. 61/843,102, filed on Jul. 5, 2013.

(51) Int. Cl. H04L 29/06

(52) U.S. Cl. CPC H04L 63/083; H04L 63/10

(57) ABSTRACT

A method of network identity authentication uses an identification code of a communication device and a network operating password. The network operating password is generated by a password generator in the website server by capturing a partial portion or all of the identification code of a website, account, transaction or other services. The result of the network identity authentication for the identification code of a communication device and network operating password is directly sent back to the network identity authentication system, thereby eliminating the possibility of invasion by a “phishing scam” or “man-in-the-middle attack,” which can happen in the conventional “dynamic password” authentication method.

This application claims the benefit of provisional U.S. Patent Application No. 61/843,102, filed Jul. 5, 2013.

### FIELD OF THE PRESENT INVENTION

The present invention provides a method of network identity authentication by using an identification code of a communication device and a network operating password, particularly for one that can solve drawbacks incurred by the hacker invasion of the “phishing scam” or “man-in-the-middle attack,” which happen in the conventional “dynamic password” authentication method.

### BACKGROUND OF THE INVENTION

Recently, Internet shopping, network online games, network financial transactions, electronic commercial activities and the like have become indispensable or prevalent in people's daily lives. However, at the same time, malicious disruptive behaviors or sabotage by cyber hackers has also become more prevalent. These disruptive behaviors or sabotage can be classified into following categories:

1. Malicious Use of Trojan horse Programs: Trojan horse or Trojan programs are malwares that appears to perform a desirable function for the user but instead facilitate unauthorized access of the user's computer system. In computer science, the Trojan horse is a program that appears to be legitimate but is designed to have destructive effects. For example, the Trojan horse may be used to steal password information, make a system more vulnerable to future unauthorized entries, or simply destroy the programs or data on a hard disk. Once a Trojan horse is installed on a target computer system, a hacker may access the computer remotely and perform various operations.

2. Phishing Scams: According to the definition from the Anti-Phishing Working Group (APWG), phishing is the criminally fraudulent process of attempting to acquire sensitive information such as usernames, passwords and credit card details by masquerading as a trustworthy entity in an electronic communication via forged email and a website that spoofs or appears to be that of a legitimate business in order to trick the victim into divulging personal confidential information such as banking account numbers, credit card information, and the like.

3. Man-in-the-Middle Attacks: In cryptography, the man-in-the-middle attack (MITM attack) is a form of active eavesdropping, in which the attacker makes independent connections with the victims and relays messages between them, making them believe that they are talking directly to each other over a private connection, when in fact the entire conversation is controlled by the attacker. The attacker is able to intercept all messages going between the two victims and inject new ones, which is straightforward in many circumstances so that the attacker can perform financial transactions with real banking websites while interactively gulling the victimized Internet user out of confidential information to incur monetary loss for the victimized Internet user.

Accordingly, in order to prevent damage from the above-listed types of network attacks, it has been proposed to use a countermeasure in the form of a dynamic One-Time Password (OTP), which is only valid for a single login session or transaction and therefore is less susceptible to replay attacks than a traditional memorized static password. The OTP may be by an organization known as an “OTP dynamic password authentication unit.” The main algorithm for the generation and delivery of OTP is based on randomness. The dynamic password is generated in an irregularly stochastic manner with a different password for each internet transaction of the internet user. If a potential intruder manages to record an OTP that has already been used to log into a service or to conduct a transaction, he or she will not be able to abuse it since it is no longer valid. As a result, even when a hacker successfully intercepts a used OTP, he/she cannot reuse the invalid used OTP or forecast a next valid new OTP to jeopardize the targeted Internet user. Therefore, the features of unpredictability, un-repeatability and one-time validity of the OTP make the OTP one of the most effective authentication solutions to solve the issues of identity authentication and preventing various cyber-crimes carried out by hacker attacks via malwares such as Trojan horse programs, phishing, spy-ware, man-in-the-middle (MITM), and the like.

The conventional authentication method using a dynamic password is illustrated in FIG. 1 including the following steps:

A. An Internet user submits an enrollment application to become a member of an “OTP dynamic password authentication unit” to get an “account number” and “password” issued to the user;

B. The Internet user accesses any website associated with the “OTP dynamic password authentication unit” by a website accessing browser and clicks on a “dynamic password authentication web-page”;

C. The Internet user inputs the “account number” and “password” issued upon membership enrollment application into respective corresponding fields of “account number” and “password” in the “dynamic password authentication web-page”;

D. After having received the “account number” and “password” input by the Internet user, the “OTP dynamic password authentication unit” will generate a set of “dynamic passwords” and make a phone call to transmit it via short message to the cellular phone designated by the Internet user for informing him or her of the current “dynamic password”;

E. The Internet user then inputs his or her own current “dynamic password” into “dynamic password authentication fields” in the “dynamic password authentication web-page” of the online website, after having read the current “dynamic password” received from the short message on his/her cellular phone;

F. The online website will relay the “dynamic password” into a computer authentication system of the “OTP dynamic password authentication unit” to perform matching comparison with the “dynamic password” previously provided to the targeted Internet user via short message. During the matching comparison of the “dynamic password”, the “dynamic password authentication web-page” of the online website will flag a phrase “login is successful” if no discrepancy is found, or a phrase “login is failed” if any discrepancy is found.

Although the above-described conventional dynamic password based authentication method has been adopted by some financial banks, online games and organizations since it was introduced and promoted, growth has been retarded since 2007 by the following bottlenecks:

1. Accessibility of cellular phones to the Internet has increased, making the dynamic password sent to the cellular phone more vulnerable. The first cellular virus “Cabir” and second cellular virus “CommWarrior” were created in June, 2004, and January, 2005, respectively. The “Cabir” virus causes an infected cellular phone to search and connect to a Bluetooth-enabled cellular phone nearby and send information to the connected cellular phone continuously, draining the battery as it keeps on seeking other Bluetooth connections. The “CommWarrior” virus is a cellular phone virus capable of replicating via Multimedia Messaging Service messages (MMS), which are text messages with images, audio or video data to be sent from one phone to another or via email. Before the arrival of “CommWarrior,” cellular phone viruses only spread over Bluetooth, and thus only nearby cellular phones were to be affected, but the “CommWarrior” (MMS) virus can affect all the cellular phones and potentially spread as quickly as an email worm, resulting in expensive losses caused by continuous short message sending by the infected cellular phones. In July, 2007, the Spanish police bureau arrested the hacker, a man of 28 years of age, who created “Cabir” and “CommWarrior.” There are over 115 thousand Symbian based smart phones affected by these two viruses.

After 2007, some cellular phone viruses were further improved to conceal themselves covertly. The Market Intelligence & Consulting Institute (MIC) of the Institute for Information Industry (Taiwan) points out that current cellular phone viruses are clever enough to hide themselves in a short message for propagation. Once a user opens the short message, this kind of malware is installed and runs quietly in the background to snatch and steal information in the affected cellular phone, and even to capture conversations covertly. Even worse, this kind of malware can copy or delete critical information such as a personal address book, short messages, calendar, bank account details, passwords and the like silently so that the user is not aware of it at all. Because each “dynamic password” in the above step D is transmitted to the Internet user via telephone short message, each “dynamic password” can be known by a hacker once he/she invades the cellular phone of the target Internet user by using spyware. Then, the hacker can easily pretend to be the target Internet user to cheat the authentication system of the “OTP dynamic password authentication unit” and defeat the function of the conventional dynamic password authentication method.

2. As described in the above step D, the “OTP dynamic password authentication unit” will generate a set of “dynamic password” and make a phone call to transmit it via short message to the cellular phone designated by the Internet user. The problem is that the expense for the short message is charged to an Internet Service Provider (ISP), which cooperates with the “OTP dynamic password authentication unit,” and that, accordingly, the Internet Service Provider (ISP) is liable not only for the expense of normal short messages but also the extra expense of abnormal or invalid short messages incurred by malware issued from competitors and hackers. Consequently, the advantage of using the “OTP dynamic password authentication mechanism” is reduced due to the unpredictable extra expense, and growth in using the conventional dynamic password authentication method has slowed.

3. Another problem is that, as described in the above step D, when the “OTP dynamic password authentication unit” generates a set of “dynamic passwords” and makes a phone call to transmit it via short message to the cellular phone designated by the Internet user, the OTP transmission uses the MT (Mobile Terminated) Mode, which is not guaranteed to be a real time and successful transmission, and can lead to a fatal authentication delay and/or mistake.

4. Furthermore, as described in the above step D, because the “OTP dynamic password authentication unit” generates a set of “dynamic passwords” and makes a phone call to transmit it via short message to the cellular phone designated by the Internet user, the Internet user must be in the status of receiving the “OTP short message” from anyone at anytime, which leads to a new fraudulent crime of “OTP short message phishing” in which the attacker constantly sends a fraudulent “OTP short message” to the victim and causes the victim to panic, thinking that his/her Internet account or banking account is under attack. Then the attacker guides the victim to follow his orders to cheat the victim and get the victim's properties.

5. As described in the above step F, the online website will relay the “dynamic password” into a computer authentication system of the “OTP dynamic password authentication unit” to perform matching comparison with the “dynamic password” previously provided to the targeted Internet user via short message, so that the “dynamic password authentication web-page” of the online website will flag a phrase “login is successful” if no discrepancy is found, or a phrase “login has failed” if any discrepancy is found. This step leads to the fraudulent crime of “man-in-the-middle attack”, in which the attacker modifies the operation command silently in the background without any sign that the victim can figure out. After the victim input the “dynamic password” to the “dynamic password authentication web-page” of the online website, the “dynamic password” matching comparison is successful and the attacker can steal Internet account or banking account of the victim.

6. Finally, in 2012, a new virus called Eurograbber with its mobile kindred Zitmo, which is mutated from the virus Zeus, prevailed in Europe to affect 16 Italian banks, 7 Spanish banks, 6 German banks and 3 Netherlands banks The attack mode of the combination of Eurograbber and Zitmo is to breach a bank defense mechanism of two-factor authentication, which functions to promote the safety of the network financial transaction, by intercepting the transaction authentication number (TAN) in the cellular phone message of the victim through infecting the victim's computer and mobile devices. Once the attacker gets the transaction authentication number (TAN), he can freely transfer the money in the victim's bank account into his assigned bank account, with each transferring amount in the range from US $656 to $328,000.

In view of the above, the existing authentication mechanisms of “dynamic password” apparently cannot effectively protect network users by controlling and stopping the above-described telephone fraud that emerges in an endless stream and is getting worse to the point where it is becoming an overwhelming situation. It is extremely critical to find a way to control and stop these kinds of cyber-crimes for protecting the network users.

### SUMMARY OF THE INVENTION

An object of the present invention is to provide a method of network identity authentication by using an identification code of a communication device and a network operating password, that includes the steps of:

a. For each access to a specific website to perform a specific operation of a specific network via the Internet, an Internet user is guided to select a communication device and an identification code of a website, account, transaction or other services as prerequisite and input a corresponding proprietary identification code of the communication device into a field for the identification code of the communication device, as well as the corresponding identification code of a website, account, transaction or other services into a field for the identification code of a website, account, transaction or other services, that are included in a dynamic web-page of the specific website for which access is sought;

b. After the website server of the specific website has received the identification code of a communication device and the identification code of a website, account, transaction or other services, a generator of a network operating password in the website server will immediately generate a corresponding network operating password by capturing a partial portion or all of the identification code of a website, account, transaction or other services and display the relationship indicator of the relationship between the network operating password and the identification code of a website, account, transaction or other services on a display of the dynamic web-page, and in the meantime will store both the identification code of the communication device and the network operating password in an verifying database of the website server;

c. By viewing the description of the relationship between the network operating password and the identification code of a website, account, transaction or other services displayed on the dynamic web-page, the Internet user can recognize the network operating password and voluntarily transmit it from the communication device to a receiving terminal designated by the specific website via telecommunication message transmitting mode; and

d. After having received the telecommunication message from the communication device, the receiving terminal will actively sense the corresponding identification code of communication device and transmit it together with the network operating password included in the telecommunication message to the verifying database of the specific website for matching comparison with counterparts of the identification code of communication device and network operating password stored in the verifying database. If the matched identification code of the communication device and the network operating password are found, an output representing the phrase “authentication is successful” or similar words will appear on the dynamic web-page of the specific website while if no matched identification code of the communication device and network operating password are found, an output representing the phrase of “authentication is failed” or similar words will appear in the same location.

In the foregoing method, the network operating password is generated by the generator of a network operating password in the website server by capturing a partial portion or all of the identification code of a website, account, transaction or other services. The result of the network identity authentication for the identification code of a communication device and network operating password is directly sent back to the network identity authentication system, instead of via conventional Internet. Therefore, no possibility of invasion of the “phishing scam” or “man-in-the-middle attack,” which can happen in the conventional “dynamic password” authentication method, exists. Thus, the method solves drawbacks incurred by the hacker invasion of the “phishing scam” or “man-in-the-middle attack,” which happen in the conventional “dynamic password” authentication method.

Another object of the present invention is to provide a method of network identity authentication by using an identification code of a communication device and a network operating password that includes advantages in steps c and d, as follows: In step c, the network operating password is voluntarily transmitted from the communication device to a receiving terminal designated by the specific website via telecommunication message transmitting mode so that the telecommunication expense is charged to the network user, which means the Internet Service Provider (ISP) is free from this kind of telecommunication expense and will have no reason to fear considerable extra telecommunication expense incurred by malignant cyber-wares from hackers or competitors. Thus, it will promote and encourage the Internet Service Provider (ISP) to adopt the present invention. In step d, the parameters for the matching comparison of identity authentication includes the identification code of a communication device and the network operating password so that the identity authentication fails if any discrepancy is found, no matter whether the discrepancy is from either the identification code of a communication device or the network operating password. With such double authenticating parameters, the security level of the present invention is much higher than that provided by the conventional “dynamic password” authentication method.

A further object of the present invention is to provide a method of network identity authentication by using an identification code of a communication device and a network operating password, including further advantages in step c, as follows: In step c, the network operating password is voluntarily transmitted from the communication device to a receiving terminal designated by the specific website via telecommunication message transmitting mode. In an event of a “phishing scam” or “man-in-the-middle attack,” even if a hacker tries to impersonate the target Internet user for performing a modified account transferring, the identity authentication will not be successful because the network operating password is derived from the identification code of a website, account, transaction or other services, and the bank account number of the hacker must be different from the original payee bank account number input by the Internet user. Thus, the present invention further prevents the hacker from passing the identity authentication even if the hacker tries to impersonate the target Internet user for criminal purposes. In other words, the security level of the present invention is much higher than that provided by the conventional “dynamic password” authentication method, particularly in the event of invasion from the “phishing scam” or “man-in-the-middle attack”.

A still further object of the present invention is to provide a method of network identity authentication by using an identification code of a communication device and a network operating password, including further advantages in step c, as follows: In step c, the network operating password is voluntarily transmitted from the communication device to a receiving terminal designated by the specific website via telecommunication message transmitting mode in MO way, which is higher priority than MT way, with the transmitting result displaying in the cellular phone of the network user. Thus, the present invention provides a more effective network identity authentication than that provided by the conventional “dynamic password” authentication method, particularly in the event of passively receiving an OTP short message.

Another object of the present invention is to provide a method of network identity authentication by using an identification code of a communication device and a network operating password, including other advantages in step c, as follows: In step c, the network operating password is voluntarily transmitted from the communication device to a receiving terminal designated by the specific website via telecommunication message transmitting mode. There is no possibility of an “OTP phishing scam”, even if a hacker tries to send fraudulent OTP message to the target Internet user for the phishing scam, because the Internet user is not expecting any OTP message from the website, account, transaction or other services. Thus, the present invention further prevents the hacker from passing the identity authentication in the “OTP phishing scam”.

### BRIEF DESCRIPTION OF THE DRAWINGS

FIG. 1 is a flow chart showing procedural steps in a conventional dynamic password authentication method.

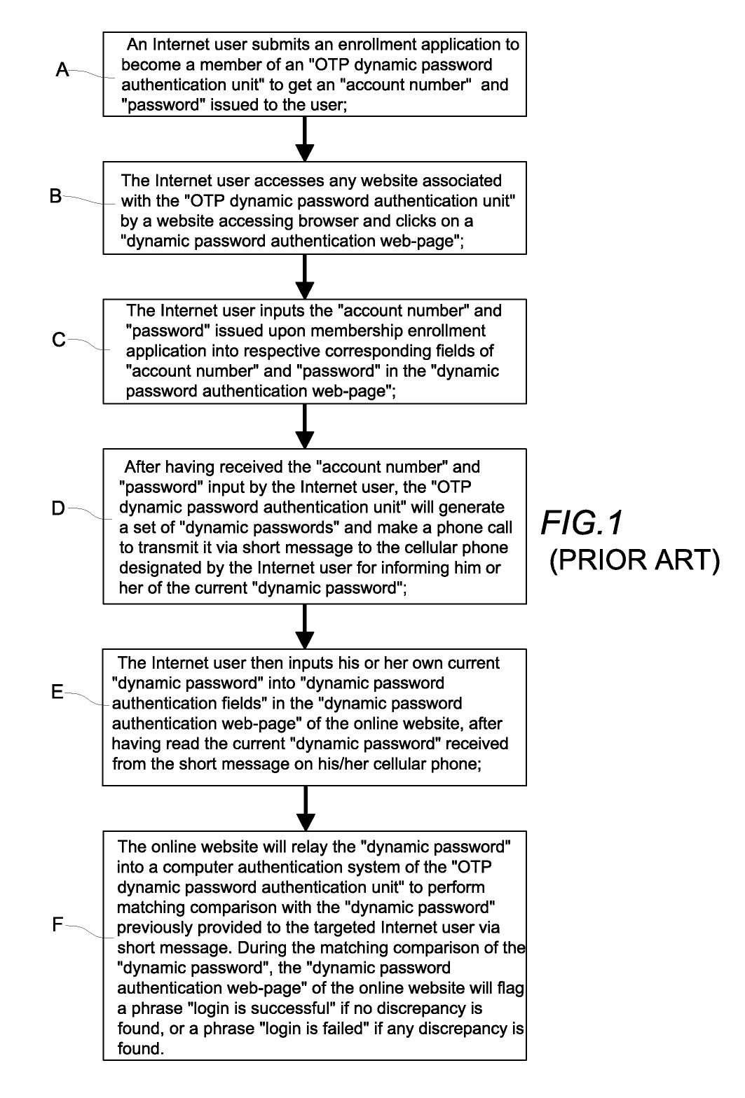

FIG. 2 is a flow chart showing procedural steps for a first exemplary embodiment of the present invention.

FIG. 3 is an operational block diagram for previous FIG. 2.

FIG. 4 is another operational block diagram of a second exemplary embodiment of the present invention.

### DETAILED DESCRIPTION OF THE PREFERRED EMBODIMENTS

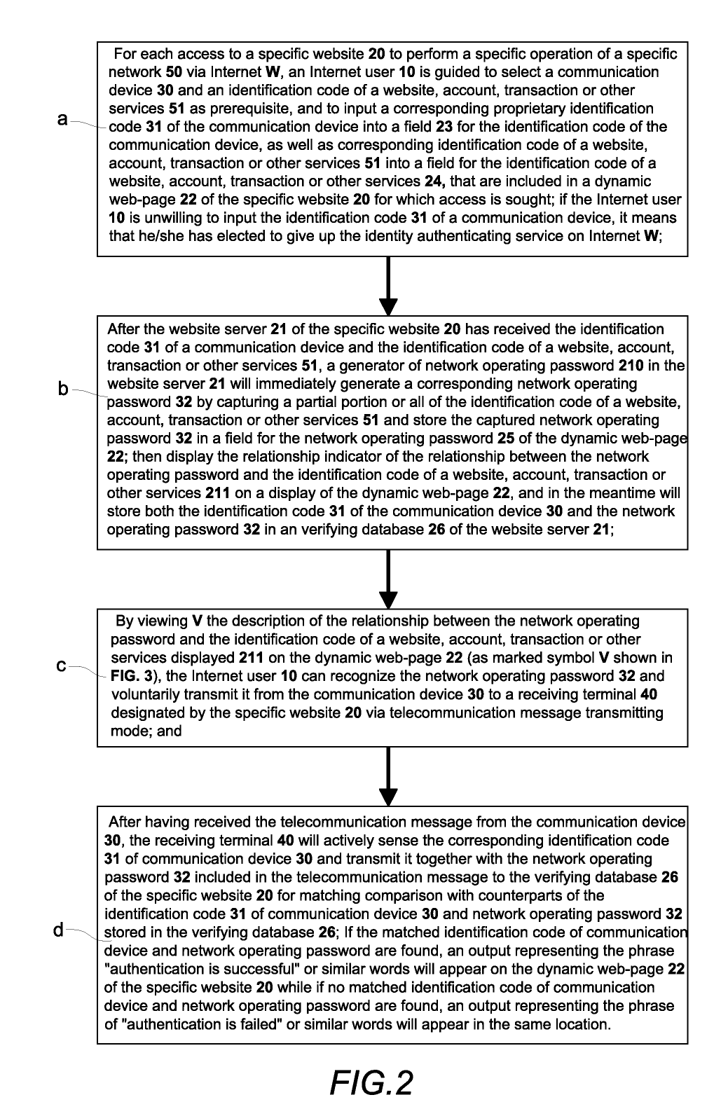

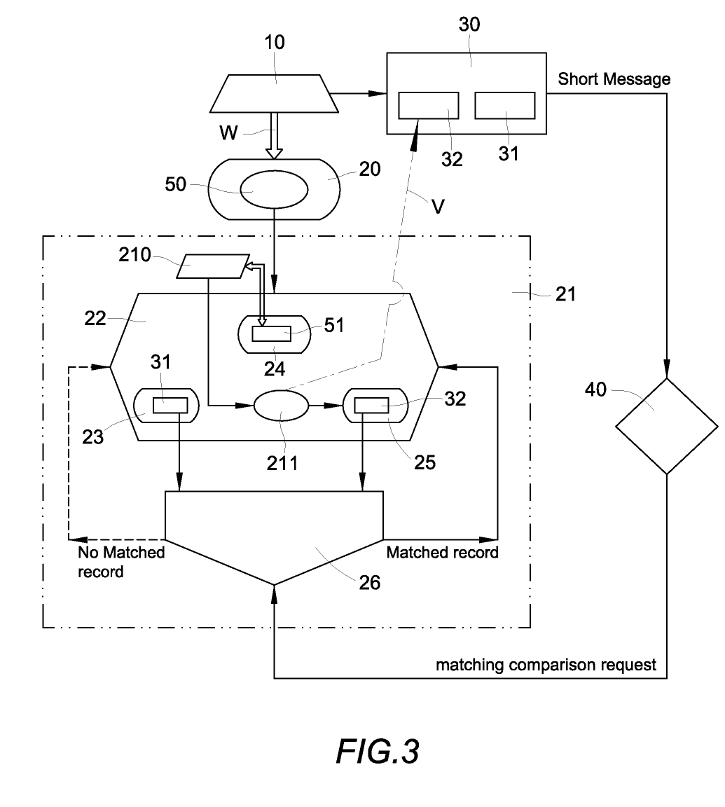

Please refer to FIGS. 2 and 3, which show a first exemplary embodiment of a “method of network identity authentication by using an identification code of a communication device and a network operating password,” comprising the following procedural steps:

a. For each access to a specific website 20 to perform a specific operation of a specific network 50 via Internet W, an Internet user 10 is guided to select a communication device 30 and an identification code of a website, account, transaction or other services 51 as prerequisite, and to input a corresponding proprietary identification code 31 of the communication device into a field 23 for the identification code of the communication device, as well as corresponding identification code of a website, account, transaction or other services 51 into a field for the identification code of a website, account, transaction or other services 24, that are included in a dynamic web-page 22 of the specific website 20 for which access is sought; if the Internet user 10 is unwilling to input the identification code 31 of a communication device, it means that he/she has elected to give up the identity authenticating service on Internet W;

b. After the website server 21 of the specific website 20 has received the identification code 31 of a communication device and the identification code of a website, account, transaction or other services 51, a generator of network operating password 210 in the website server 21 will immediately generate a corresponding network operating password 32 by capturing a partial portion or all of the identification code of a website, account, transaction or other services 51 and store the captured network operating password 32 in a field for the network operating password 25 of the dynamic web-page 22; then display the relationship indicator of the relationship between the network operating password and the identification code of a website, account, transaction or other services 211 on a display of the dynamic web-page 22, and in the meantime will store both the identification code 31 of the communication device 30 and the network operating password 32 in an verifying database 26 of the website server 21;

c. By viewing V the description of the relationship between the network operating password and the identification code of a website, account, transaction or other services displayed 211 on the dynamic web-page 22 (as marked symbol V shown in FIG. 3), the Internet user 10 can recognize the network operating password 32 and voluntarily transmit it from the communication device 30 to a receiving terminal 40 designated by the specific website 20 via telecommunication message transmitting mode; and

d. After having received the telecommunication message from the communication device 30, the receiving terminal 40 will actively sense the corresponding identification code 31 of communication device 30 and transmit it together with the network operating password 32 included in the telecommunication message to the verifying database 26 of the specific website 20 for matching comparison with counterparts of the identification code 31 of communication device 30 and network operating password 32 stored in the verifying database 26; If the matched identification code of communication device and network operating password are found, an output representing the phrase “authentication is successful” or similar words will appear on the dynamic web-page 22 of the specific website 20 while if no matched identification code of communication device and network operating password are found, an output representing the phrase of “authentication is failed” or similar words will appear in the same location.

In the above step a, if the communication device 30 is a telephone in a fixed telephone network, the corresponding identification code 31 of communication device 30 is the telephone number thereof while if the communication device 30 is a cellular phone, the corresponding identification code 31 of communication device 30 is the cellular phone number thereof or data exiting in a subscriber identity module (SIM) thereof.

In the above step b, if the identification code of a website, account, transaction or other services 51 is a website address of the specific website 20, the corresponding network operating password 32 is a partial portion or all of the website address of the specific website 20 captured by the generator of network operating password 210; if the identification code of a website, account, transaction or other services 51 is a bank account of a network bank, the corresponding network operating password 32 of communication device 30 is a partial portion or all of the bank account of the network bank captured by the generator of network operating password 210; or if the identification code of a website, account, transaction or other services 51 is a transactional serial number of an electronic commerce, the corresponding network operating password 32 of communication device 30 is a partial portion or all of the transactional serial number of the electronic commerce captured by the generator of network operating password 210.

In the above step c, the telecommunication message transmitting mode can be replaced by a telecommunication voice/speech transmitting mode, telecommunication image/video transmitting mode or network message transmitting mode including unstructured supplementary services data (USSD).

Moreover, in above step d, the telephone number of the receiving terminal 40 can be replaced by a telecommunication short code such that either the telephone number or the telecommunication short code is made available to the public via propagation of a media advertisement.

Therefore, when a Internet user 10 accesses the specific website 20 via the Internet W (for example a network bank) to perform an operation of a specific network 50 for, by way of example, a specific account transferring, and he/she selects a legitimate cellular phone with a cellular phone number of, by way of example, “123456789” as the communication device 30, then the required input for the corresponding proprietary identification code of communication device 31 is “123456789,” which is input in the field for the identification code of communication device 23 for the dynamic web-page 22 of the specific website 20. Then, if assigned bank account number of the specific payee account is “112233445566,” then the required input for the corresponding proprietary identification code of a specific operation of a specific network 51 is “112233445566,” which is input in the field for the identification code of a specific operation of a specific network 24 for the dynamic web-page 22 of the specific website 20;

After the website server 21 of the specific website 20 has received the identification code 31 of a communication device “123456789” and the identification code of a specific operation of a specific network 51 “112233445566,” a generator 210 of a network operating password in the website server 21 of the specific website 20 will immediately generate a corresponding network operating password 32 by capturing partial portion “445566” of the identification code of a specific operation of a specific network 51 and store the captured network operating password 32 “445566” in a field 25 for network operating password of the dynamic web-page 22; then display it in a relationship indicator 211 of network operating password and identification code of a website, account, transaction or other services of the dynamic web-page 22, and in the meantime will store both the identification code 31 of the communication device “123456789” and the network operating password 32 “445566” in an verifying database 26 of the website server 21;

Then, the Internet user 10 will recognize network operating password 32 “445566” by viewing the relationship indicator of the relationship between the network operating password and the identification code of a website, account, transaction or other services 211 on a display of the dynamic web-page 22 of the specific website 20. At this moment, the Internet user 10 can transmit “123456789” as identification code 31 of the communication device 30 with “445566” as the network operating password 32 from his/her communication device 30 to a receiving terminal 40 designated by the specific website 20 via telecommunication message transmitting mode to enable identity authentication for accessing the network bank website to start transferring from the account.

As a result, in an event of no “phishing scam” and no “man-in-the-middle attack”, even a hacker who already knows that the cellular phone number of the target Internet user 10 is “123456789” still cannot pass the identity authentication because the hacker cannot easily get a cellular phone having the same identification code as “123456789” or the same identification code of communication device 31 of the communication device 30. Thus, the hacker cannot pass the identity authentication to impersonate “123456789” and access the target Internet bank website for criminal purposes.

Similarly, in the event of a “phishing scam” or “man-in-the-middle attack” in which a hacker tries to impersonate the target Internet user 10 for performing account transferring, the hacker cannot pass the identity authentication because the network operating password 32 is derived from the identification code of a specific operation of a specific network 51, and the bank account number of the hacker must be different from the original payee bank account number input by the Internet user 10. Thus, the present invention further prevents the hacker from passing the identity authentication even if the hacker tries to impersonate the target Internet user 10 for criminal purposes.

Thus, the security level of the present invention is much higher than that provided by the conventional “dynamic password” authentication method, particularly in an event of “phishing scam” or “man-in-the-middle attack”. Therefore the present invention provides an easy and safe way to carry out Internet transactions for all Internet users.

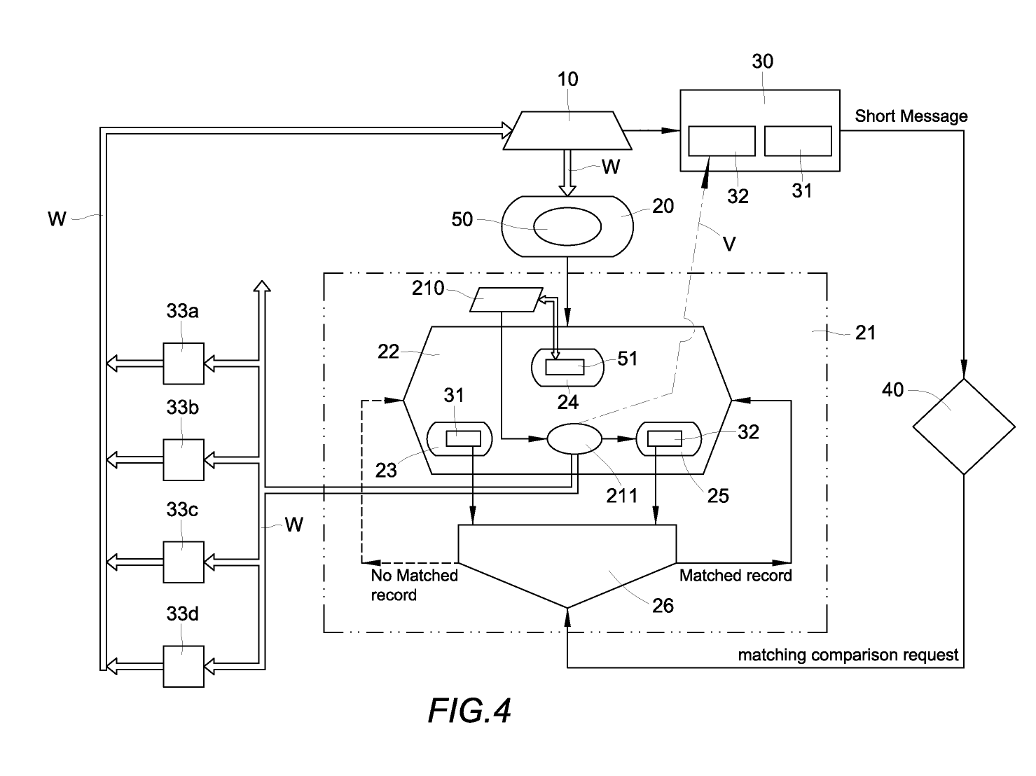

Please further refer to FIG. 4. Wherein in above step b, the display for the relationship indicator of network operating password and identification code of a website, account, transaction or other services 211 is an email 33a, a network communication voice/speech 33b, a telecommunication voice/speech 33c or a network communication message 33d for informing the network user 10.

What is claimed is:

1. A method of network identity authentication by using an identification code of a communication device and a network operating password, comprising the steps of:
a. for each access to a specific website to perform a specific operation of a specific network via Internet, an Internet user is guided to select a communication device and input the corresponding identification code of the communication device into a field for the identification code of the communication device as well as the corresponding identification code of the specific operation into a field for the identification code of the specific operation that are included in a dynamic web-page of the specific website for which access is sought;
b. after the website server of the specific website has received the identification code of the communication device and the identification code of the specific operation, a generator of an network operating password in the website server generates the network operating password by capturing a partial portion or all of the identification code of the specific operation and displays the relationship indicator of the relationship between the network operating password and the identification code of the specific operation on a display of the dynamic-webpage, and the website server stores both the identification code of the communication device and the network operating password in an verifying database of the website server;
c. upon viewing the description of the relationship between the network operating password and the identification code of the specific operation displayed on the dynamic-webpage, the Internet user recognizes the network operating password and voluntarily transmits it from the communication device to a receiving terminal designated by the specific website via message transmitting mode; and
d. after having received the message from the communication device, the receiving terminal gets the corresponding identification code of communication device and transmits it together with the network operating password included in the message to the verifying database of the specific website for matching comparison with counterparts of the identification code of communication device and network operating password stored in the verifying database; if the matched identification code of communication device and network operating password are found, an output corresponding to the passed authentication is executed by the dynamic web-page of the specific website; and if no matched identification code of communication device and network operating password are found, an output corresponding to the failed authentication is executed by the dynamic web-page.

2. The method as claimed in claim 1, wherein the communication device in step (a) is a telephone in a fixed telephone network, and the identification code of the communication device is the telephone number thereof.

3. The method as claimed in claim 1, wherein the communication device in step (a) is a cellular phone, and the identification code of the communication device is a cellular phone number thereof.

4. The method as claimed in claim 1, wherein the communication device in step (a) is a cellular phone, and the identification code of the communication device includes data in a subscriber identity module (SIM) thereof.

5. The method as claimed in claim 1, wherein the display for the relationship indicator of the network operating password and the identification code of a website, account, transaction or other services in step (b) is an email, network communication voice/speech, telecommunication voice/speech, or a message.

6. The method as claimed in claim 1, wherein the identification code of a website, account, transaction or other services in step (b) is a website address of the specific website, and the corresponding network operating password is a partial portion or all of the website address of the specific website.

7. The method as claimed in claim 1, wherein the identification code of a website, account, transaction or other services in step (b) is a bank account number of a network bank, and the corresponding network operating password is a partial portion or all of the bank account number of the network bank.

8. The method as claimed in claim 1, wherein the identification code of a website, account, transaction or other services in step (b) is a transactional serial number of an electronic commerce, and the corresponding network operating password is a partial portion or all of the transactional serial number of the electronic commerce.

9. The method as claimed in claim 1, wherein the message transmitting mode in step (c) is replaced by a voice/speech transmitting mode or image/video transmitting mode.

10. The method as claimed in claim 1, wherein the telephone number of the receiving terminal in step (d) is replaced by a telecommunication short code.

11. The method as claimed in claim 1, wherein the message transmitting mode in step (c) includes network communication message, telecommunication message and unstructured supplementary services data (USSD).
